(19) United States
(12) Patent Application Publication
(10) Pub. No.: US 2025/0297094 A1
(43) Pub. Date: Sep. 25, 2025

(54) MODIFIED POLYESTER MATERIAL, POLYESTER COMPOSITION AND PRODUCT THEREOF

(71) Applicant: NAN YA PLASTICS CORPORATION, Taipei City (TW)

(72) Inventors: Ching-Yao Yuan, Taipei City (TW); Wen-Cheng Yang, Taipei City (TW); Chun-Che Tsao, Taipei City (TW); Chia-Yen Hsiao, Taipei City (TW); Ci Syuan Liou, Taipei City (TW)

(73) Assignee: NAN YA PLASTICS CORPORATION, Taipei City (TW)

(21) Appl. No.: 18/665,541

(22) Filed: May 15, 2024

(30) Foreign Application Priority Data
Mar. 20, 2024 (TW) 113110235

(51) Int. Cl. C08L 67/02; C08K 7/14

(52) U.S. Cl. CPC C08L 67/02; C08K 7/14; C08L 2205/025; C08L 2205/03

(57) ABSTRACT

A modified polyester material, a polyester composition and a product thereof are provided. The modified polyester material includes a polyester raw material (A), a crystal nucleating agent (B), a transesterification inhibitor (C), a lubricant (D), and an antioxidant (E). The polyester raw material (A) includes a polyethylene terephthalate virgin resin, a recycled polyethylene terephthalate or a combination thereof.

### CROSS-REFERENCE TO RELATED APPLICATION

This application claims the priority benefit of Taiwan application serial no. 113110235, filed on Mar. 20, 2024. The entirety of the above-mentioned patent application is hereby incorporated by reference herein and made a part of this specification.

### BACKGROUND

### Technical Field

The invention relates to a polyester material, and in particular to a modified polyester material, a polyester composition and a product thereof.

### Description of Related Art

As environmental awareness increases, reducing carbon emissions and ESG indicators are the direction and goals of various countries and brands in the near future. After polybutylene terephthalate (PBT) is modified by introducing ingredients such as a glass fiber and a flame retardant, it may have good dielectric properties and is widely applied in electronic appliances, automobiles, industrial valves and other fields. However, polybutylene terephthalate has poor recyclability and unstable recycling sources, such that a product formed by using polybutylene terephthalate is gradually unable to satisfy the environmental protection and carbon reduction needs of the end customers.

### SUMMARY

The invention provides a modified polyester material, a polyester composition and a product thereof with good physical properties and heat resistance.

A modified polyester material of the invention includes a polyester raw material (A), a crystal nucleating agent (B), a transesterification inhibitor (C), a lubricant (D) and an antioxidant (E). The polyester raw material (A) includes a polyethylene terephthalate (PET) virgin resin, a recycled polyethylene terephthalate (RPET) or a combination thereof.

In an embodiment of the invention, an intrinsic viscosity (IV) of the polyester raw material (A) is 0.7 dL/g to 0.9 dL/g.

In an embodiment of the invention, the crystal nucleating agent (B) includes an organic crystal nucleating agent, an inorganic crystal nucleating agent or a combination thereof.

In an embodiment of the invention, the transesterification inhibitor (C) includes a phosphite ester-based compound, a phosphate ester-based compound or a combination thereof.

In an embodiment of the invention, the lubricant (D) includes a stearate, a polyethylene wax, a silicone modifier, a fluorine-based resin or a combination thereof.

In an embodiment of the invention, the antioxidant (E) includes a hindered phenolic-based antioxidant, a phenolic-based antioxidant, a phosphite ester-based antioxidant, a complex antioxidant or a combination thereof.

In an embodiment of the invention, based on a total usage amount of the modified polyester material being 100 parts by weight, a usage amount of the polyester raw material (A) is 70 parts by weight to 90 parts by weight, a usage amount of the crystal nucleating agent (B) is 8 parts by weight to 20 parts by weight, a usage amount of the transesterification inhibitor (C) is 0.5 part by weight to 2 parts by weight, a usage amount of the lubricant (D) is 0.2 part by weight to 2 parts by weight, a usage amount of the antioxidant (E) is 0.5 part by weight to 2 parts by weight.

A polyester composition of the invention includes the modified polyester material above, a polybutylene terephthalate and a reinforcing material.

In an embodiment of the invention, a content of the recycled polyethylene terephthalate is 20% by weight to 40% by weight based on a total weight of the polyester composition.

In an embodiment of the invention, based on a total usage amount of the polyester composition being 100 parts by weight, a usage amount of the modified polyester material is 25 parts by weight to 45 parts by weight, a usage amount of the polybutylene terephthalate is 30 parts by weight to 55 parts by weight, a usage amount of the reinforcing material is 20 parts by weight to 40 parts by weight.

A product of the invention is made by using the polyester composition above as an engineering plastic particle.

Based on the above, the modified polyester material of the invention is modified by adding a crystal nucleating agent (B), a transesterification inhibitor (C), a lubricant (D) and an antioxidant (E) to a polyester raw material (A). Thus, the modified polyester material may have good crystallization speed, fluidity, mechanical properties, heat resistance and processability. In addition, the modified polyester material of the invention may be introduced to a polybutylene terephthalate to form a polyester composition. Thus, the polyester composition may have good crystallinity, heat resistance and mechanical properties. In addition, the polyester composition of the invention may be processed as an engineering plastic pellet to enhance the features of the product by introducing environmentally friendly recycled materials and reducing carbon emissions.

In order to make the features and advantages of the invention more obvious and understandable, examples are given below for detailed description.

### DESCRIPTION OF THE EMBODIMENTS

The following are examples that describe the content of the invention in detail. The implementation details provided in the embodiments are for illustrative purposes and are not intended to limit the scope of protection of the invention. Anyone with ordinary knowledge in the art may modify or change these implementation details according to the needs of the actual implementation. Additionally, descriptions of well-known devices, methods, and materials may be omitted so as not to obscure the various principles of the invention.

A range herein may be expressed as from “about” one specific value to “about” another specific value, and it may also be expressed directly as one specific value and/or to another specific value. In expressing ranges, another embodiment includes from the one particular value and/or to another particular value. Similarly, when a value is expressed as an approximation by use of the antecedent “about,” it will be understood that the particular value forms another embodiment. It will be further understood that the endpoints of each range are clearly related or independent of the other endpoints.

Herein, non-limiting terms (such as: may, can, for example or other similar terms) refer to unessential or optional implementation, inclusion, addition or existence.

Unless otherwise defined, all terms (including technical and scientific terms) used herein have the same meaning as commonly understood by those with ordinary knowledge in the art. It will also be understood that terms (such as those defined in commonly used dictionaries) shall be construed to have a meaning consistent with their meaning in the relevant technical context and shall not be construed in an idealized or overly formal sense, except expressly so defined herein.

### <Modified Polyester Material>

The invention provides a modified polyester material, which includes a polyester raw material (A), a crystal nucleating agent (B), a transesterification inhibitor (C), a lubricant (D) and an antioxidant (E). In addition, the modified polyester material of the invention may further include other suitable additives according to needs. Each of the above components will be described in detail as follows.

### Polyester Raw Material (A)

The polyester raw material (A) includes a polyethylene terephthalate virgin resin, a recycled polyethylene terephthalate or a combination thereof. The sources of the recycled polyethylene terephthalate include a packaging material recycling pellet, a film material recycling pellet, a fabric recycling pellet, an industrial recycling environmentally friendly recycled polyester pellet or other suitable polyethylene terephthalate products to achieve the needs of introducing the recycled materials, but is not limited thereto. The packaging material recycled pellet may include a bottle recycled pellet (such as PET bottle recycled pellet), a tray recycled pellet or other suitable packaging material products.

In this embodiment, an intrinsic viscosity of the polyester raw material (A) is 0.7 dL/g to 0.9 dL/g, preferably 0.72 dL/g to 0.82 dL/g. When the intrinsic viscosity of the polyester raw material (A) is less than 0.7 dL/g, the polyester raw material (A) may have too low impact strength, thereby causing the polyester composition including the modified polyester material or a product thereof having the problems with insufficient strength and/or embrittlement. When the intrinsic viscosity of the polyester raw material (A) is greater than 0.9 dL/g, the polyester raw material (A) may have an excessively high viscosity, thereby causing the polyester composition including the modified polyester material to have poor fluidity and thus, not easy to apply in subsequent processing processes.

Based on a total usage amount of the modified polyester material being 100 parts by weight, a usage amount of the polyester raw material (A) is 70 parts by weight to 90 parts by weight, preferably 80 parts by weight to 85 parts by weight.

### Crystal Nucleating Agent (B)

The crystal nucleating agent (B) is not particularly limited, and suitable crystal nucleating agent may be selected according to needs. In this embodiment, the crystal nucleating agent (B) may include an organic crystal nucleating agent, an inorganic crystal nucleating agent or other suitable crystal nucleating agent, preferably a combination of an organic crystal nucleating agent and an inorganic crystal nucleating agent. When a combination of an organic crystal nucleating agent and an inorganic crystal nucleating agent is used, a ratio of the usage amount of the organic crystal nucleating agent to a usage amount of the inorganic crystal nucleating agent is 1:4 to 4:1, preferably 1:2 to 2:1.

For example, the organic crystal nucleating agent may include an organic acid sodium salt or other suitable organic crystal nucleating agents. The organic acid sodium salt may include sodium benzoate, sodium montanate, EMAA (trade name, Surlyn resin, manufactured by DuPont) or other suitable organic acid sodium salts, preferably sodium benzoate, EMAA (trade name) or a combination thereof. The inorganic crystal nucleating agent may include micro-nano level inorganic powder or other suitable inorganic crystal nucleating agents. The micro-nano level inorganic powder may include talc powder, titanium dioxide, silicon dioxide, calcium carbonate or other suitable inorganic powders, preferably talc powder.

Based on a total usage amount of the modified polyester material being 100 parts by weight, a usage amount of the crystal nucleating agent (B) is 8 parts by weight to 20 parts by weight, preferably 12 parts by weight to 18 parts by weight.

When the modified polyester material includes a crystal nucleating agent (B), the crystallization and solidification speed of the modified polyester material may be improved and its heat resistance may be effectively improved.

### Transesterification Inhibitor (C)

The transesterification inhibitor (C) is not particularly limited, and suitable transesterification inhibitor may be selected according to needs. In this embodiment, the transesterification inhibitor (C) may include a phosphite ester-based compound, a phosphate ester-based compound or other suitable transesterification inhibitors. For example, the transesterification inhibitor (C) may include phosphite ester, triphenyl phosphate, triphenyl phosphite or other suitable transesterification inhibitors, preferably phosphite ester.

Based on a total usage amount of the modified polyester material being 100 parts by weight, a usage amount of the transesterification inhibitor (C) is 0.5 part by weight to 2 parts by weight, preferably 0.5 part by weight to 1 part by weight.

As the modified polyester material includes the transesterification inhibitor (C), when the modified polyester material is introduced to the polybutylene terephthalate to form a polyester composition, the transesterification reaction easily occurred between polyethylene terephthalate and polybutylene terephthalate may be inhibited to prevent the cleavage of polyethylene terephthalate and polybutylene terephthalate, thereby improving the impact strength resistance and mechanical properties of the polyester composition.

### Lubricant (D)

The lubricant (D) is not particularly limited, and suitable lubricant may be selected according to needs. In this embodiment, the lubricant (D) may include a stearate, a polyethylene wax, a silicone modification, a fluorine-based resin or other suitable lubricants, preferably a polyethylene wax.

Based on a total usage amount of the modified polyester material being 100 parts by weight, a usage amount of the lubricant (D) is 0.2 part by weight to 2 parts by weight, preferably 0.5 part by weight to 1 part by weight.

When the modified polyester material includes a lubricant (D), the fluidity of the modified polyester material may be improved. When the modified polyester material is introduced to the polybutylene terephthalate to form a polyester composition, it helps to improve the flow and demoulding properties of subsequent processing processes (such as injection molding).

### Antioxidant (E)

The antioxidant (E) is not particularly limited, and suitable antioxidant may be selected according to needs. In this embodiment, the antioxidant (E) may include a hindered phenolic-based antioxidant, a phenolic-based antioxidant, a phosphite ester-based antioxidant, a complex antioxidant or other suitable antioxidants, preferably the complex antioxidant. For example, the complex antioxidant may include a combination of a hindered phenolic-based antioxidant (such as antioxidant 1010) and a phosphite ester-based antioxidant (such as antioxidant 168) or other suitable antioxidant combinations. A mixed weight ratio of the hindered phenolic-based antioxidant and the phosphite ester-based antioxidant may be 3:1 to 1:3, preferably 2:1 to 1:2.

Based on a total usage amount of the modified polyester material being 100 parts by weight, a usage amount of the antioxidant (E) is 0.5 part by weight to 2 parts by weight, preferably 0.5 part by weight to 1 part by weight.

When the modified polyester material includes the antioxidant (E), the heat resistance and processability of the modified polyester material may be improved.

### <Polyester Composition>

An exemplary embodiment of the invention provides a polyester composition including the modified polyester material above, a polybutylene terephthalate, and a reinforcing material. In addition, the polyester composition of the invention may further include other suitable additives according to needs.

The polybutylene terephthalate is not particularly limited, and suitable polybutylene terephthalate may be selected according to needs. For example, the polybutylene terephthalate may include a polybutylene terephthalate with flame retardancy or a polybutylene terephthalate without flame retardancy. Specific examples of commercially available products of the polybutylene terephthalate with flame retardancy may include Changchun PBT 2000 series (trade name; manufactured by Chang Chun Plastics Co., Ltd.) or other suitable polybutylene terephthalate with flame retardancy. Specific examples of commercially available products of the polybutylene terephthalate without flame retardancy include Changchun PBT 1200 (trade name; manufactured by Chang Chun Plastics Co., Ltd.) or other polybutylene terephthalate without flame retardancy.

The reinforcing material is not particularly limited, and suitable reinforcing material may be selected according to needs. For example, the reinforcing material may include a glass fiber, a carbon fiber, a boron fiber or other suitable reinforcing materials, preferably a glass fiber.

In this embodiment, based on a total weight of the polyester composition, a content of a recycled polyethylene terephthalate in the polyester raw material (A) in the modified polyester material is 20% by weight to 40% by weight, preferably 25% by weight to 35% by weight. When the polyester composition is processed as an engineering plastic pellet, it may improve the features of the product by introducing environmentally friendly recycled materials and reducing carbon emissions.

Based on a total usage amount of the polyester composition being 100 parts by weight, a usage amount of the modified polyester material is 25 parts by weight to 45 parts by weight, preferably 31 parts by weight to 40 parts by weight; a usage amount of the polybutylene terephthalate is 30 parts by weight to 55 parts by weight, preferably 33 parts by weight to 40 parts by weight; a usage amount of the reinforcing material is 20 parts by weight to 40 parts by weight, preferably 25 parts by weight to 35 parts by weight.

### <Product>

An exemplary embodiment of the invention provides a product made by using the polyester composition as an engineering plastic particle.

For example, the polyester composition may be processed into a product as an engineering plastic pellet. The processing process is not particularly limited, and suitable processing method may be selected according to needs. The processing process may include extrusion molding, injection molding, sheet metal processing methods or other suitable processing methods.

Hereinafter, the invention will be described in detail with reference to examples. The following examples are provided to describe the invention, and the scope of the invention includes the scope described in the following claims and their substitutions and modifications, and is not limited to the scope of the examples.

### EXAMPLES

### Examples of Modified Polyester Material

81.5 parts by weight of the recycled polyethylene terephthalate (intrinsic viscosity being 0.746 dL/g), 16 parts by weight of the crystal nucleating agent (in which a ratio of the usage amount of the organic crystal nucleating agent to a usage amount of the inorganic crystal nucleating agent is 1:1, wherein the organic crystal nucleating agent is a combination of sodium benzoate and EMAA (in which the mixed weight ratio is 1:15), the inorganic crystal nucleating agent is talc powder), 1 part by weight of the phosphite ester, 0.5 part by weight of the polyethylene wax and 1 part by weight of the complex antioxidant (in which the mixed weight ratio of the antioxidant 1010 to the antioxidant 168 is 1:1) were placed in a blender and stir it until it is uniformly mixed into a solution state. Other additives may be added according to needs. After mixing uniformly, a liquid modified polyester material may be obtained.

### Examples of Polyester Composition

The component types and usage amounts of the polyester compositions of Example 1 to Example 2 and Comparative Example 1 to Comparative Example 4 are listed in Table 1 below. The prepared polyester composition was analyzed in the following test methods, and the results are shown in Table 1.

### Test Methods

Impact Strength Resistance: Tested according to ASTM D256 standard. The obtained value (kg-cm/cm) is the total energy that the polyester composition may withstand when broken. The higher the value, the higher the impact strength (or the resistance strength of the polyester composition) that the polyester composition may withstand.

Tensile Strength: Tested according to ASTM D638 standard. The obtained value is the total energy that the polyester composition may withstand against tensile deformation. The higher the value, the higher the tensile strength the polyester composition may withstand.

Flexural Strength: Tested according to ASTM D790 standard. The obtained value is the ability of the polyester composition to resist bending deformation. The higher the value, the higher the flexural strength the polyester composition may withstand.

Flexural Modulus: Tested according to ASTM D790 standard. The obtained value is the total energy of the polyester composition to resist bending deformation. The higher the value, the higher the rigidity of the polyester composition.

Heat Deflection Temperature (HDT): Tested under a pressure of 1.82 MPa according to ASTM D648 standard. The obtained value is the ability of the polyester composition to resist thermal deformation. The higher the value, the higher the heat resistance of the polyester composition.

Glossiness: Tested according to ASTM D523 standard. The obtained value is the ability of the surface of the test piece of the polyester composition to reflect light. The higher the value, the brighter the surface of the test piece.

Shrinkage Rate: Tested according to ASTM D955 standard. The obtained value is the error percentage between the size of the product made from the polyester composition after cooling, solidification and demoulding and the size of the original mold. The smaller the value, the closer the size of the product is to the original mold size.

Flame Retardant Test: Tested according to UL94 specifications. The thickness of the test piece is 1.5 mm. The obtained value is the ability of the polyester composition to inhibit or resist the spread of flames.

TABLE 1

| Component | | Examples | |
|---|---|---|---|
| (unit: parts by weight) | | 1 | 2 |
| Polyester material | Modified polyester | 36 | 36 |
| | material prepared in | | |
| | Example | | |
| | RPET (trade name: | — | — |
| | 6EX01, manufactured | | |
| | by Nan Ya Plastics | | |
| | Corporation, IV being | | |
| | 0.8 dL/g) | | |
| Polybutylene | Changchun PBT 1200 | 34 | — |
| terephthalate | Changchun PBT 2000 | — | 34 |
| | series | | |
| Reinforcing | Glass fiber (model | 30 | 30 |
| material | 3786) | | |
| Actual content of RPET (wt %) | | 30 | 30 |
| Mechanical | Impact strength resistance (kg- | 8.2 | 7.6 |
| Properties | cm/cm) | | |
| | Tensile strength (MPa) | 133.5 | 132.8 |
| | Flexural strength (MPa) | 216 | 219 |
| | Flexural Modulus (MPa) | 9070 | 9300 |
| | Heat deflection temperature | 213 | 213 |
| | (° C.) | | |
| | Glossiness (GU) | 83.1 | 74.3 |
| | Shrinkage rate (%) | 0.36 | 0.27 |
| | Flame retardant test | HB | V-0 |

| Component | | Comparative Examples | | | |
|---|---|---|---|---|---|
| (unit: parts by weight) | | 1 | 2 | 3 | 4 |
| Polyester material | Modified polyester | — | — | — | — |
| | material prepared in | | | | |
| | Example | | | | |
| | RPET (trade name: | — | — | 30 | 30 |
| | 6EX01, manufactured | | | | |
| | by Nan Ya Plastics | | | | |
| | Corporation, IV being | | | | |
| | 0.8 dL/g) | | | | |
| Polybutylene | Changchun PBT 1200 | 70 | — | 40 | — |
| terephthalate | Changchun PBT 2000 | — | 70 | — | 40 |
| | series | | | | |
| Reinforcing | Glass fiber (model | 30 | 30 | 30 | 30 |
| material | 3786) | | | | |
| Actual content of RPET (wt %) | | 0 | 0 | 30 | 30 |
| Mechanical | Impact strength resistance (kg- | 8.4 | 7.7 | 6.9 | 5.8 |
| Properties | cm/cm) | | | | |
| | Tensile strength (MPa) | 131.1 | 133.7 | 120.3 | 127.4 |
| | Flexural strength (MPa) | 218 | 220 | 196 | 205 |
| | Flexural Modulus (MPa) | 8890 | 9020 | 9060 | 9140 |
| | Heat deflection temperature | 212 | 210 | 192 | 196 |
| | (° C.) | | | | |
| | Glossiness (GU) | 81.8 | 75.8 | 58.5 | 49.3 |
| | Shrinkage rate (%) | 0.35 | 0.25 | 0.36 | 0.27 |
| | Flame retardant test | HB | V-0 | HB | V-0 |

*Actual content of RPET: The content of the recycled polyethylene terephthalate based on the total weight of the polyester composition.
*Glass fiber (model 3786): format is a short fiber with a diameter of 10 microns and a length of 4.5 mm.

As may be seen from Table 1, in Example 1 to Example 2 of the polyester composition including the modified polyester material of this embodiment, based on the total weight of the polyester composition, the content of the recycled polyethylene terephthalate is about 30% by weight, that is, it has the characteristics of introducing environmentally friendly recycled materials into products and reducing carbon emissions, and has good impact strength resistance, tensile strength, flexural strength, flexural modulus, heat deflection temperature, glossiness and shrinkage rate. In addition, when the polyester composition includes the polybutylene terephthalate with flame retardancy (Example 2), the polyester composition may pass the flame retardant test. On the other hand, Comparative Example 1 to Comparative Example 2 of the polyester composition including the polyester material which only includes polybutylene terephthalate do not include any environmentally friendly recycled materials, and may not achieve the features of introducing environmentally friendly recycled materials into products and reducing carbon emissions.

In addition, regarding the polyester composition in which environmentally friendly recycled materials are introduced, compared with the polyester composition that does not include the modified polyester material of this embodiment (Comparative Examples 3 to 4), the polyester composition including the modified polyester material of this embodiment (Examples 1 to 2) has better impact strength resistance, tensile strength, flexural strength, heat deflection temperature and glossiness.

In addition, regarding the polyester composition including polybutylene terephthalate without flame retardancy, compared to the polyester composition that does not include the modified polyester material of this embodiment (Comparative Example 3), the polyester composition including the modified polyester material of this embodiment (Example 1) has better impact strength resistance, tensile strength, flexural strength, flexural modulus, heat deflection temperature and glossiness.

In addition, regarding the polyester composition including polybutylene terephthalate with flame retardancy, compared to the polyester composition that does not include the modified polyester material of this embodiment (Comparative Example 4), the polyester composition including the modified polyester material of this embodiment (Example 2) has better impact strength resistance, tensile strength, flexural strength, flexural modulus, heat deflection temperature and glossiness.

Based on the above, when the modified polyester material of the invention includes a polyester raw material (A), a crystal nucleating agent (B), a transesterification inhibitor (C), a lubricant (D) and an antioxidant (E), the polyester composition including thereof may have the characteristics of introducing environmentally friendly recycled materials into products and reducing carbon emissions, and has good impact strength resistance, tensile strength, flexural strength, flexural modulus, heat deflection temperature, glossiness and shrinkage rate. The polyester composition of the invention may combine the advantages of polyethylene terephthalate and polybutylene terephthalate, and may have good dielectric properties, heat resistance, mechanical properties and glossiness, and thus, widely used in electronic appliances, automobiles, industrial valves and other fields.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A modified polyester material, comprising:
a polyester raw material (A) containing a polyethylene terephthalate virgin resin, a recycled polyethylene terephthalate or a combination thereof;
a crystal nucleating agent (B);
a transesterification inhibitor (C);
a lubricant (D); and
an antioxidant (E).

2. The modified polyester material according to claim 1, wherein an intrinsic viscosity of the polyester raw material (A) is 0.7 dL/g to 0.9 dL/g.

3. The modified polyester material according to claim 1, wherein the crystal nucleating agent (B) contains an organic crystal nucleating agent, an inorganic crystal nucleating agent or a combination thereof.

4. The modified polyester material according to claim 1, wherein the transesterification inhibitor (C) contains a phosphite ester-based compound, a phosphate ester-based compound or a combination thereof.

5. The modified polyester material according to claim 1, wherein the lubricant (D) contains a stearate, a polyethylene wax, a silicone modifier, a fluorine-based resin or a combination thereof.

6. The modified polyester material according to claim 1, wherein the antioxidant (E) contains a hindered phenolic-based antioxidant, a phenolic-based antioxidant, a phosphite ester-based antioxidant, a complex antioxidant or a combination thereof.

7. The modified polyester material according to claim 1, wherein based on a total usage amount of the modified polyester material being 100 parts by weight, a usage amount of the polyester raw material (A) is 70 parts by weight to 90 parts by weight, a usage amount of the crystal nucleating agent (B) is 8 parts by weight to 20 parts by weight, a usage amount of the transesterification inhibitor (C) is 0.5 part by weight to 2 parts by weight, a usage amount of the lubricant (D) is 0.2 part by weight to 2 parts by weight, a usage amount of the antioxidant (E) is 0.5 part by weight to 2 parts by weight.

8. A polyester composition, comprising:
the modified polyester material according to claim 1;
a polybutylene terephthalate; and
a reinforcing material.

9. The polyester composition according to claim 8, wherein based on a total weight of the polyester composition, a content of the recycled polyethylene terephthalate is 20% by weight to 40% by weight.

10. The polyester composition according to claim 8, wherein based on a total usage amount of the polyester composition being 100 parts by weight, a usage amount of the modified polyester material is 25 parts by weight to 45 parts by weight, a usage amount of the polybutylene terephthalate is 30 parts by weight to 55 parts by weight, a usage amount of the reinforcing material is 20 parts by weight to 40 parts by weight.

11. A product made by using the polyester composition according to claim 8 as an engineering plastic pellet.
